(19) United States
(12) Patent Application Publication
(10) Pub. No.: US 2008/0137850 A1
(43) Pub. Date: Jun. 12, 2008

(54) METHOD AND SYSTEM FOR A GENERIC KEY PACKET FOR MPEG-2 TRANSPORT SCRAMBLING

(76) Inventor: Rajesh Mamidwar, San Diego, CA (US)

Correspondence Address: MCANDREWS HELD & MALLOY, LTD, 500 WEST MADISON STREET, SUITE 3400, CHICAGO, IL, 60661, US

(21) Appl. No.: 11/743,494

(22) Filed: May 2, 2007

Related U.S. Application Data
(60) Provisional application No. 60/869,010, filed on Dec. 7, 2006.

(51) Int. Cl. H04N 7/167; H04K 1/00; H04L 9/00

(52) U.S. Cl. 380/202; 380/210; 380/29

(57) ABSTRACT

Methods and systems for a generic key packet for MPEG-2 transport scrambling and descrambling are disclosed and may comprise descrambling multiple package identifier channels in a transport stream utilizing a single generic key packet. The single generic key packet may comprise scrambling keys for each of the multiple package identifier channels, and may comprise scrambling keys for time intervals corresponding to two or more successive key change points. A key change point may be enabled to occur at the same time instant for each of the multiple package identifier channels, or may be enabled to occur at different time instants for one or more of the multiple package identifier channels. The scrambling/descrambling may comprise copy protection or conditional access descrambling. The generic key change packet may comprise information identifying a scrambling/descrambling algorithm, such as AES, DES and 3-DES, for example.

### CROSS-REFERENCE TO RELATED APPLICATIONS/INCORPORATION BY REFERENCE

This application makes reference to, claims priority to, and claims the benefit of U.S. Provisional Application Ser. No. 60/869,010, filed on Dec. 7, 2006.

This application also makes reference to:
U.S. Patent Application Ser. No. ______ (Attorney Docket No. 18117US02) filed on even date herewith.

Each of the above stated applications is hereby incorporated herein by reference in its entirety.

### FEDERALLY SPONSORED RESEARCH OR DEVELOPMENT

[Not Applicable]

### MICROFICHE/COPYRIGHT REFERENCE

[Not Applicable]

### FIELD OF THE INVENTION

Certain embodiments of the invention relate to multimedia signal processing. More specifically, certain embodiments of the invention relate to a method and system for a generic key packet for MPEG-2 transport scrambling.

### BACKGROUND OF THE INVENTION

As the speed of Internet traffic increases, on-demand television and video are becoming closer and closer to reality. The introduction of broadband networks, headend and terminal devices such as set-top boxes, and media such as DVD disks recorded with digitally compressed audio, video and data signals, for example, which utilize Motion Picture Expert Group (MPEG) compression standards, may provide sound and picture quality that is virtually indistinguishable from the original material. One of the most popular MPEG standards is MPEG-2, which provides the necessary protocols and infrastructure that may be used for delivering digital television or DVD contents with compressed audio, video and data signals. The MPEG-2 compression scheme compresses and packetizes the video content into MPEG-2 packets. A detailed description of the MPEG-2 standard is published as ISO/IEC Standard 13818.

In addition to the increasing speed of Internet transactions, continued advancement of motion picture content compression standards permit high quality picture and sound while significantly reducing the amount of data that must be transmitted. A compression standard for television and video signals was developed by the Moving Picture Experts Group (MPEG), and is known as MPEG-2. An encoded bitstream, such as an MPEG-2 bitstream, comprises different types of data. For example, an MPEG-2 bitstream may comprise audio information, video information, and additional data. A transmitted MPEG-2 bitstream may be received by a set-top box (STB), for example, and the STB may further process the received bitstream. However, since the received bitstream comprises multiple types of data, the STB may utilize multiple decoders. Using multiple decoders to parse the received bitstream is time consuming and may result in processing delays. Furthermore, audio glitches may be generated during decoding when the transport stream input rate, or the played stream rate, may be different from the actual stream rate.

To ensure that data remains secure during communication, various keys may be utilized to process the data prior to transmission and to process received data. For example, keys may be utilized to scramble and descramble the multiple channels in a transport stream. These keys may change after a desired time interval to increase security. As the number of channels increases and the time interval between key changes decreases, processing requirements of the system may become significant.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for a generic key packet for MPEG-2 transport scrambling, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is an exemplary generic key packet generating head-end system, in accordance with an embodiment of the invention.

FIG. 1B is an exemplary copy protection descrambling/scrambling system, in accordance with an embodiment of the invention.

FIG. 2 is a block diagram illustrating conventional entitlement control message package identifier channels, in connection with an embodiment of the invention.

FIG. 3 is a block diagram of generic key change packets, in accordance with an embodiment of the invention.

FIG. 4 is a flow diagram illustrating exemplary steps in a copy protection descrambling and scrambling scheme, in accordance with an embodiment of the invention.

### DETAILED DESCRIPTION OF THE INVENTION

Certain aspects of the invention may be found in a method and system for a generic key packet for MPEG-2 transport scrambling. Exemplary aspects of the invention include descrambling multiple package identifier channels in a transport stream utilizing a single generic key packet. The single generic key packet may comprise scrambling keys for each of the multiple package identifier channels, and may comprise scrambling keys for time intervals corresponding to two or more successive key change points. A key change point may be enabled to occur at the same time instant for each of the multiple package identifier channels, or may be enabled to occur at different time instants for one or more of the multiple package identifier channels. The scrambling/descrambling may comprise copy protection or conditional access descrambling. The generic key change packet may comprise information identifying a scrambling/descrambling algorithm, such as AES, DES and 3-DES, for example.

In instances when MPEG-2 systems are used in data processing, programs received by a set top box may be scrambled and keys that are used for scrambling may be changed periodically, for example once every N seconds. Each scrambled PID channel can have a separate key PID channel, or an entitlement control message (ECM) PID channel. In conventional MPEG2 based systems, each ECM packet may carry only one key at any time. As the number of scrambled PID channels increases in a system, the number of ECM PID channels also increases, which may add complexity due to the increasing number of PID channels to be supported in a system. As per current requirements for set top boxes, multiple programs need to be supported and each program may have multiple ECM PID channels. As multiple ECM packets arrive at multiple instances, the frequency of required CPU intervention may increase as keys in an ECM packet have to be processed before actual usage. The ECM packet content may change some fixed time before the key change interval, and the same ECM packet may be repeated multiple times to reduce channel change time, i.e. while changing channel, a key may need to be acquired first, and may be transmitted continuously once in 50 to 100 ms apart.

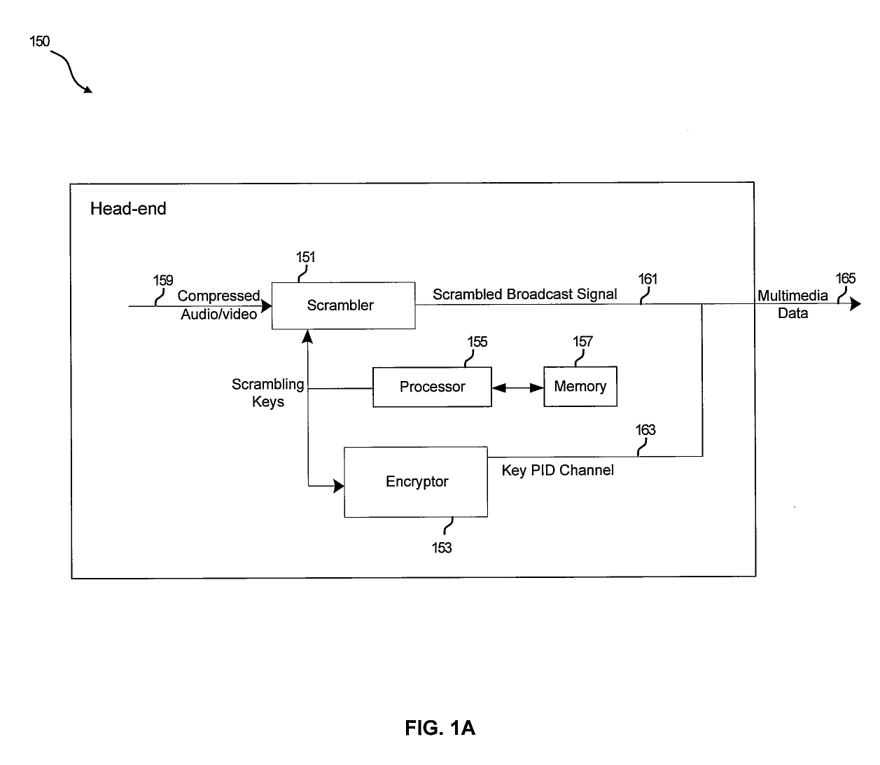

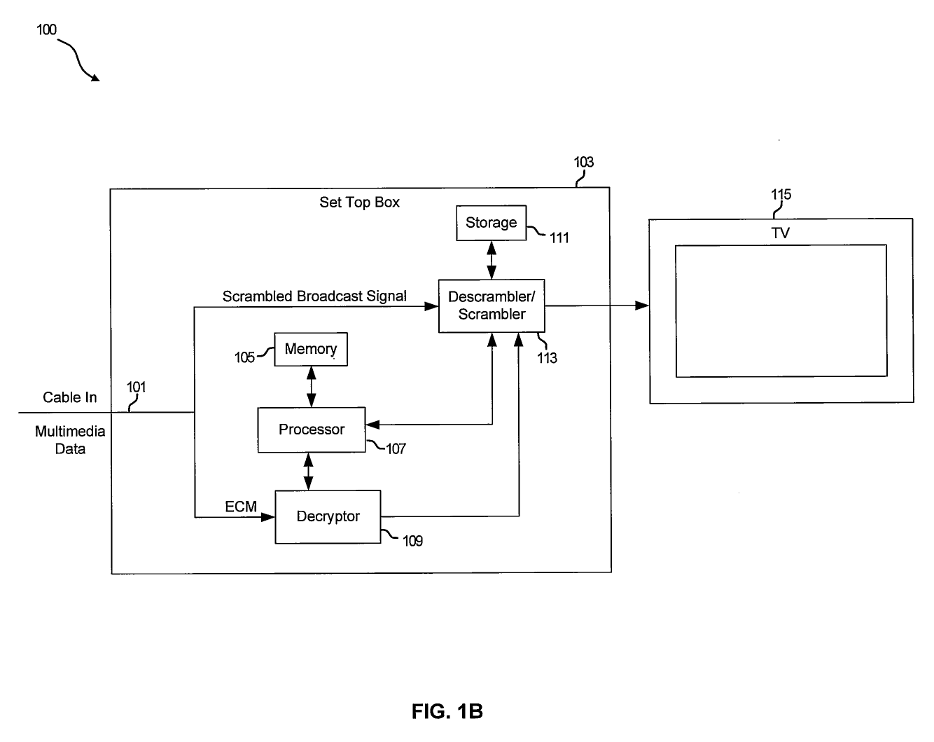

FIG. 1A is an exemplary generic key packet generating head-end system, in accordance with an embodiment of the invention. Referring to FIG. 1A, there is shown a block diagram of an exemplary head-end comprising a scrambler 151, an encryptor 153, a processor 155 and a memory 157.

The memory 157 may comprise suitable circuitry, logic and/or code that may be enabled to store data that may be utilized by the processor 155 to control the scrambler 151 and the encryptor 153. The scrambler 151 may comprise suitable circuitry, logic and/or code that may be enabled to scramble compressed audio/video 159 utilizing scrambling keys generated by the processor 155. The encryptor 153 may comprise suitable circuitry, logic and/or code that may be enabled to encrypt the scrambling keys to generate a key PID channel 163. The processor 155 may comprise suitable circuitry, logic and/or code that may be enabled to generate scrambling keys that may be utilized by the scrambler 151 and the encryptor 153 to generate a scrambled multimedia signal 165.

In operation, during signal scrambling in the head-end 150, the scrambling keys may determine the scrambling pattern and may be communicated to the scrambler 151 and the encryptor 153 by the processor 155. The scrambler 151 may be enabled to, for example, copy protect scramble or conditional access scramble the compressed audio/video 159. The scrambling key may be changed at fixed intervals of time, such as every few seconds, to maintain a secure system. The scrambling keys may, therefore, be continuously transmitted to the subscriber's receiver, or set-top box 103, as described with respect to FIG. 1B. This may be achieved in the head-end 150 by encrypting the scrambling keys utilizing the encryptor 153 and transmitting the encrypted scrambling keys within the key PID channel 163.

FIG. 1B is an exemplary generic key packet receiving set-top box system, in accordance with an embodiment of the invention. Referring to FIG. 1, there is shown generic key packet set-top box system 100 comprising a cable input 101, a television 115 and a set top box 103 comprising a memory 105, a processor 107, a decryptor 109, a storage 111 and a descrambler/scrambler block 113.

The cable input 101 may communicate copy protection and/or conditional access scrambled MPEG-2 multimedia signals, which may be generated by the head-end 150 described with respect to FIG. 1A, and may comprise audio, video, data and/or voice, for example.

The set top box 103 may comprise suitable circuitry, logic and/or code for receiving copy protection scrambled or conditional access scrambled multimedia input signals and generating an output signal that may be displayed on the television 115 and/or stored on the storage 111. The set top box 103 may be configured to support multiple programs, multiple key change points and/or a single generic key packet (GKP).

The storage 111 may comprise suitable circuitry, logic and/or code that may be enabled to store a broadcast signal received from the cable input 101 that may have been descrambled by the descrambler/scrambler block 113. The broadcast signal may be rescrambled by the descrambler/scrambler block 113 before storing on the storage 111. Although a cable input 101 is shown, the invention is not so limited. Accordingly, other media inputs such as, for example, a satellite feed or a wireless network connection may be provided as an input to the set top box 103.

The memory 105 may comprise suitable circuitry, logic and/or code that may be enabled to store data that may be utilized by the processor 107 to control the descrambler/scrambler block 113 and the decryptor 109.

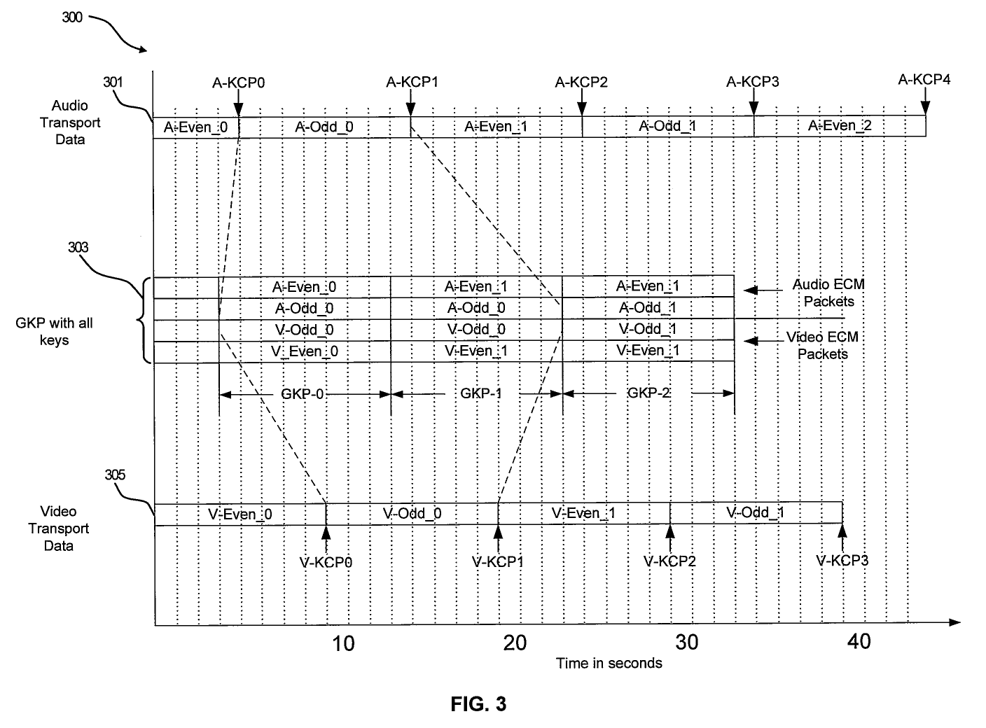

The decryptor 109 may comprise suitable circuitry, logic and/or code that may be enabled to decrypt a generic key packet PID channel to generate scrambling keys that nay be utilized by the descrambler/scrambler block 113 to descramble a scrambled broadcast signal for display on the TV 115 and/or for re-scrambling the signal before storing on the storage 111. The generic key packet PID channel may comprise scrambling keys for all channels communicated to the set-top box 103 by the cable input 101 and may be described further with respect to FIG. 3.

The processor 107 may comprise suitable circuitry, logic and/or code that may be enabled to receive scrambling keys that may be utilized by the descrambler/scrambler block 113 and the decryptor 109 to generate an unscrambled signal that may be displayed on the TV 115.

The descrambler/scrambler block 113 may comprise suitable circuitry, logic and/or code that may be enabled to receive a scrambled broadcast signal, for example, the cable input 101 and descrambling the scrambled broadcast signal utilizing the generic key packet PID channel for display on the TV 115. The descrambler/scrambler block 113 may be enabled to re-scramble the descrambled data for copy protection (CP) prior to storing on the storage 111.

In operation, a multimedia transport stream may be communicated to the set top box 103 via the cable input 101. In instances where the multimedia transport stream may be scrambled for copy protection (CP) or conditional access (CA), for example, the descrambler/scrambler block 113 may descramble the broadcast signal before communicating a signal to the television 115 and may CP scramble the descrambled broadcast signal before storing the data from the descrambled broadcast signal in the storage 111. The descrambling keys may be obtained by the set top box 103 from a separate PID channel comprising a generic key packet (GKP), which may contain multiple keys for multiple PID channels. This is in contrast to conventional systems which may utilize multiple key packet PID channels greatly increasing system complexity.

The generic key packet set-top box system 100 may comprise various exemplary functions such as a scrambling/descrambling function, an entitlement control function, and an entitlement management function. The scrambling/descrambling function may be designed to make the program incomprehensible to unauthorized receivers. Scrambling may be applied commonly or separately to the different elementary stream components of a program. For example, the video, audio and data stream components of a TV program may be scrambled in order to make these streams unintelligible. Scrambling may be achieved by applying various scrambling algorithms to the stream components. The scrambling algorithm usually utilizes a descrambling key. Once the signal is received, the descrambling may be achieved by any receiver that holds the descrambling key, used by the scrambling algorithm prior to transmission. Scrambling and descrambling operations, in general, may not cause any impairment in the quality of the signals. The descrambling key used by the scrambling algorithm may be a secret parameter known only by the scrambler and the authorized descramblers. In order to preserve the integrity of the encryption process, the control word may be changed frequently in order to avoid any exhaustive searches by an unauthorized user, which may be intended to discover the descrambling key.

The generic key packet set-top box system 100 may be enabled to scramble and/or randomize transmitted data bits so that unauthorized decoders may not decode the transmitted data bits. Authorized decoders may be delivered a key that initializes the circuit that inverts the data bit randomization. In one aspect of the invention, the scrambling may be associated with the pseudo-random inversion of data bits based on a key that may be valid for a short period of time. In addition to scrambling, a key may also be transformed into an encrypted key in order to protect it from any unauthorized users. In various embodiments of the invention, the CA system descrambling/scrambling system 100 may be enabled to utilize key encryption, and the encrypted keys may be securely distributed.

The generic key packet set-top box system 100 may be enabled to provide protection against signal piracy, efficient scrambling, flexibility, support for a variety of formats, and ease of implementation.

For CA or CP, private (secure) keys may be used for scrambling and descrambling high-value content or for protecting highly sensitive transactions. In a CP system, the content scrambling key may be protected. To ensure proper functionality, the CP system may perform scrambling according to the properties of the data for transmission. In addition, the CP system may be enabled to change the key regularly to maintain the security of the scrambling system, and transmit the key information to the receiver in a secure manner using, for example, a hierarchical encryption system.

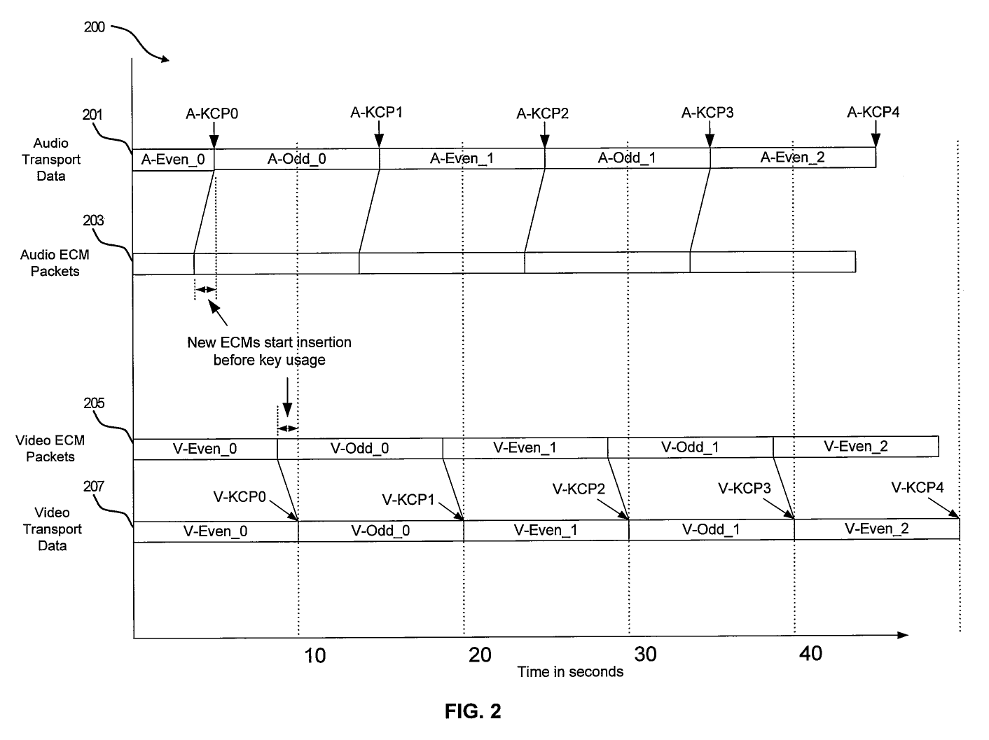

FIG. 2 is a block diagram illustrating conventional entitlement control message package identifier channels, in connection with an embodiment of the invention. Referring to FIG. 2, there is shown transport stream 200 comprising audio transport data 201, audio ECM packets 203, video ECM packets 205 and video transport data 207. Key change points (KCPs), or instances where the scrambling key may change, such as from odd to even or even to odd, for example, are indicated in FIG. 2 by A-KCP0, A-KCP1, A-KCP2, A-KCP3 and A-KCP4 for the audio transport data 201, and V-KCP0, V-KCP1, V-KCP2, V-KCP3 and V-KCP4 for the video transport data 207.

In operation, the ECM packets 203 and 205 may be inserted just before the key change points, such that the appropriate key may be present at the start of a data packet, such as from the audio transport data 201 or the video transport data 207. Each ECM packet may be received, processed, and loaded to a key table prior to the start of a data packet. In addition, a separate ECM channel may be required for each PID channel. Thus, as the number of scrambled programs and the number of PID channels per program increases, conventional systems may have greatly increased complexity. In addition, with these increased programs and PID channels as well as demands for decreased key change intervals, excessively stringent speed requirements may be placed on a processor in a set top box for processing the ECM changes.

FIG. 3 is a block diagram of generic key change packets, in accordance with an embodiment of the invention. Referring to FIG. 3, there is shown transport stream 300 comprising audio transport data 301, generic key packet (GKP) 303 and video transport data 305. Key change points (KCPs), or instances where the scrambling key may change, such as from odd to even or even to odd, for example, are indicated in FIG. 3 by A-KCP0, A-KCP1, A-KCP2, A-KCP3 and A-KCP4 for the audio transport data 301, and V-KCP0, V-KCP1, V-KCP2, V-KCP3 and V-KCP4 for the video transport data 305. The KCPs may occur at the same time or at different times for the PID channels comprising the audio transport data 301 and the video transport data 305. The invention is not limited to the number of PID channels illustrated in FIG. 3. Accordingly, the number of PID channels may be dependent on the requirements of the set top box or service provider, for example.

The GKP 303 may comprise the scrambling key packets for all PID channels, such as the audio transport data 301 and the video transport data 305. The key packets in the GKP 303 at any instant may comprise the scrambling keys for the audio transport data 301 and the video transport data 305, and any other PID channels that may be incorporated, for the current time interval as well as the next interval. In this manner, the number and frequency of scrambling key loading and storing processes may be decreased, reducing the speed requirements of a processor in a set top box, such as the set top box 103, described with respect to FIG. 1.

In operation, the transport stream comprising the audio transport data 301 and the video transport data 305 may be received by a set top box, such as the set top box 103, described with respect to FIG. 1. The received transport stream may be copy protection or conditional access scrambled, for example. The GKP 303 may comprise the descrambling keys required for each of the PID channels, such as the audio transport data 301 and the video transport data 305, for the current time interval as well as the next interval. In this manner, the number of ECM PID channels may be reduced to one, such as the GKP 303, as opposed to one for each data PID channel, as with conventional systems described with respect to FIG. 2. This may reduce the requirements of a processor in a set top box, such as the set top box 103 described with respect to FIG. 1. In addition, since the GKP 303 may include the scrambling keys for the current time interval as well as the next, the speed requirements of a processor in a set top box, such as the set top box 103 described with respect to FIG. 1, may be relaxed.

In addition to the scrambling keys, the GKP 303 packets may comprise the type of algorithm that may be utilized in the descrambling/scrambling process, such as advanced encryption standard (AES), data encryption standard (DES), 3-DES, for example. The algorithm may change at each key change point, or remain constant, while the scrambling key changes from odd to even or even to odd.

Although the generic key packet scheme described here may be utilized for MPEG-2 transport, the technique may be utilized in any application where multiple key packets may be used for multiple services within the same group simultaneously, and may comprise copy protection scrambling and/or conditional access scrambling.

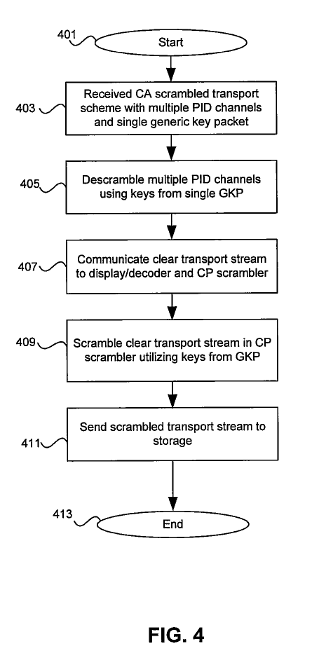

FIG. 4 is a flow diagram illustrating exemplary steps in a copy protection descrambling and scrambling scheme, in accordance with an embodiment of the invention. Referring to FIG. 4, after start step 401 in step 403, a scrambled transport stream with multiple PID channels 301 and 305 and a single generic key packet (GKP) 303 may be received by the descrambler/scrambler 105. In step 405, the multiple PID channels of the transport stream 101 may be descrambled utilizing the single GKP. In step 407, the clear transport stream may be communicated to a decoder and/or display and may also be communicated to a CP scrambler within the descrambler/scrambler 105. In step 409, the CP scrambler within the descrambler/scrambler 305 may scramble the clear transport stream. In step 411, the CP scrambled transport stream may be communicated to the storage 107, followed by end step 413.

In an embodiment of the invention, a method and system are disclosed for scrambling and descrambling multiple package identifier channels 301 and 305 in a transport stream utilizing a single generic key packet 303. The single generic key packet 303 may comprise scrambling keys for each of the multiple package identifier channels 301 and 305, and may comprise scrambling keys for time intervals corresponding to two or more successive key change points A-KCP0, A-KCP1, A-KCP2, A-KCP3, A-KCP4, V-KCP0, V-KCP1, V-KCP2 and/or V-KCP3. A key change point may be enabled to occur at the same time instant for each of the multiple package identifier channels 301 and 305, or may be enabled to occur at different time instants for one or more of the multiple package identifier channels. The scrambling/descrambling may comprise copy protection or conditional access descrambling. The generic key change packet 303 may comprise information identifying a scrambling/descrambling algorithm, such as AES, DES and 3-DES, for example.

Certain embodiments of the invention may comprise a machine-readable storage having stored thereon, a computer program having at least one code section for communicating information within a network, the at least one code section being executable by a machine for causing the machine to perform one or more of the steps described herein.

While the invention has been described in connection with the MPEG-2 standard, the invention is not so limited and may be applicable to other existing or future MPEG or other standards and/or formats.

Accordingly, aspects of the invention may be realized in hardware, software, firmware or a combination thereof. The invention may be realized in a centralized fashion in at least one computer system or in a distributed fashion where different elements are spread across several interconnected computer systems. Any kind of computer system or other apparatus adapted for carrying out the methods described herein is suited. A typical combination of hardware, software and firmware may be a general-purpose computer system with a computer program that, when being loaded and executed, controls the computer system such that it carries out the methods described herein.

One embodiment of the present invention may be implemented as a board level product, as a single chip, application specific integrated circuit (ASIC), or with varying levels integrated on a single chip with other portions of the system as separate components. The degree of integration of the system will primarily be determined by speed and cost considerations. Because of the sophisticated nature of modern processors, it is possible to utilize a commercially available processor, which may be implemented external to an ASIC implementation of the present system. Alternatively, if the processor is available as an ASIC core or logic block, then the commercially available processor may be implemented as part of an ASIC device with various functions implemented as firmware.

The present invention may also be embedded in a computer program product, which comprises all the features enabling the implementation of the methods described herein, and which when loaded in a computer system is able to carry out these methods. Computer program in the present context may mean, for example, any expression, in any language, code or notation, of a set of instructions intended to cause a system having an information processing capability to perform a particular function either directly or after either or both of the following: a) conversion to another language, code or notation; b) reproduction in a different material form. However, other meanings of computer program within the understanding of those skilled in the art are also contemplated by the present invention.

While the invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

What is claimed is:

1. A method for processing data in a communication system, the method comprising:
descrambling multiple package identifier channels in a transport stream utilizing a single generic key packet, wherein said single generic key packet comprises scrambling keys for each of said multiple package identifier channels.

2. The method according to claim 1, wherein said single generic key packet comprises scrambling keys for time intervals corresponding to two or more successive key change points.

3. The method according to claim 1, wherein a key change point is enabled to occur at the same time instant for each of said multiple package identifier channels.

4. The method according to claim 1, wherein a key change point is enabled to occur at different time instants for one or more of said multiple package identifier channels.

5. The method according to claim 1, wherein said descrambling comprises copy protection descrambling.

6. The method according to claim 1, wherein said descrambling comprises conditional access descrambling.

7. The method according to claim 1, wherein said generic key change packet comprises information identifying a descrambling algorithm for said descrambling.

8. The method according to claim 7, wherein said descrambling algorithm comprises one of: AES, DES and 3-DES.

9. A method for processing data in a communication system, the method comprising:
generating a single generic key packet comprising scrambling keys for multiple package identifier channels in a transport stream wherein said scrambling keys are utilized to scramble said multiple package identifier channels.

10. The method according to claim 9, wherein said single generic key packet comprises scrambling keys for time intervals corresponding to two or more successive key change points.

11. The method according to claim 9, wherein said key change point is enabled to occur at the same time instant for one or more of said multiple package identifier channels.

12. The method according to claim 9, wherein said key change point is enabled to occur at different time instants for one or more of said multiple package identifier channels.

13. The method according to claim 9, wherein said scrambling comprises one of: copy protection and conditional access scrambling.

14. The method according to claim 9, wherein said single generic key packet comprises information identifying an algorithm utilized for said scrambling.

15. The method according to claim 14, wherein said scrambling comprises one of: AES, DES and 3-DES.

16. A system for processing data in a communication system, the system comprising:
at least one processor that descrambles multiple package identifier channels in a transport stream utilizing a single generic key packet, wherein said single generic key packet comprises scrambling keys for each of said multiple package identifier channels.

17. The system according to claim 16, wherein said single generic key packet comprises scrambling keys for time intervals corresponding to two or more successive key change points.

18. The system according to claim 16, wherein a key change point is enabled to occur at the same time instant for each of said multiple package identifier channels.

19. The system according to claim 16, wherein a key change point is enabled to occur at different time instants for one or more of said multiple package identifier channels.

20. The system according to claim 16, wherein said descrambling comprises copy protection descrambling.

21. The system according to claim 16, wherein said descrambling comprises conditional access descrambling.

22. The system according to claim 16, wherein a key change point comprises information identifying a descrambling algorithm for said descrambling.

23. The system according to claim 22, wherein said descrambling algorithm comprises one of: AES, DES and 3-DES.

24. A system for processing data in a communication system, the system comprising:
at least one processor that generates a single generic key packet comprising scrambling keys for multiple package identifier channels in a transport stream wherein said scrambling keys are utilized to scramble said multiple package identifier channels.

25. The system according to claim 24, wherein said single generic key packet comprises scrambling keys for time intervals corresponding to two or more successive key change points.

26. The system according to claim 24, wherein a key change point is enabled to occur at the same time instant for one or more of said multiple package identifier channels.

27. The system according to claim 24, wherein a key change point is enabled to occur at different time instants for one or more of said multiple package identifier channels.

28. The system according to claim 24, wherein said scrambling comprises one of: copy protection and conditional access scrambling.

29. The system according to claim 24, wherein said single generic key packet comprises information identifying an algorithm utilized for said scrambling.

30. The system according to claim 29, wherein said scrambling comprises one of: AES, DES and 3-DES.
